(19) United States
(12) Patent Application Publication
(10) Pub. No.: US 2002/0159119 A1
(43) Pub. Date: Oct. 31, 2002

(54) Method and system for providing dispersion and dispersion slope compensation

(76) Inventors: Timothy Fries, Kensington, MD (US); Harshad Sardesai, Ellicott City, MD (US)

Correspondence Address: CIENA Corporation, Legal Department, 1201 Winterson Rd., Linthicum, MD, 21090, US

(21) Appl. No.: 09/844,826

(22) Filed: Apr. 27, 2001

(51) Int. Cl. H04B 10/00; H04B 10/12

(52) U.S. Cl. 359/161; 359/173

(57) ABSTRACT

An exemplary embodiment of the invention is an optical communications network transmitting signals on multiple wavelengths. The network includes a first dispersion compensating fiber providing dispersion compensation and dispersion slope compensation. The first dispersion compensating fiber has a first non-zero dispersion coefficient and a first non-zero dispersion slope coefficient. The network also includes a second dispersion compensating fiber in optical communication with the first dispersion compensating fiber. The second dispersion compensating fiber has a second non-zero dispersion coefficient and a second non-zero dispersion slope coefficient. The lengths of first dispersion compensating fiber and second dispersion compensating fiber are selected to compensate dispersion and compensate dispersion slope in a transmission path in optical communication with the first dispersion compensating fiber and the second dispersion compensating fiber. The compensation of dispersion and dispersion slope in the transmission fiber path occurs simultaneously for multiple wavelengths. Alternate embodiments include a method of compensating dispersion in an optical communications network.

### BACKGROUND OF THE INVENTION

1. Field of Invention

The invention relates generally to a method and system for providing dispersion and dispersion slope compensation.

2. Description of Related Art

Dispersion is a known phenomenon in optical networks that causes a broadening of input pulses as they travel along the length of the fiber. One type of dispersion relevant to the invention is chromatic dispersion (also referred to as “material dispersion” or “intramodal dispersion”), caused by a differential delay of various wavelengths of light in a waveguide material.

Dispersion has a limiting effect on the ability to transmit high data rates. When modulated onto an optical carrier, an optical spectrum is broadened in linear proportion to the bit rate. The interaction of the broadened optical spectrum with wavelength-dependent group velocity (i.e., dispersion) in the fiber introduces signal distortions. The amount of tolerable distortion is inversely proportional to the bit rate. Thus, the combination of increasing spectral broadening and decreasing distortion tolerance makes the overall propagation penalty proportional to the square of bit rate.

This results, for example, in a 10 Gbps signal being 16 times less tolerant to dispersion than 2.5 Gbps signal, while having only 4 times the bit rate. Dispersion accumulates linearly with propagation distance in the fiber and typical propagation distances in standard single-mode fiber (e.g., SMF-28 or equivalent) are ˜1000 km at 2.5 Gbps, 60 km at 10 Gbps, and only ˜4 km at 40 Gbps. Clearly, some form of dispersion compensation is required to obtain meaningful propagation distances at bit rates of 10 Gbps and above.

Fiber-optic system transport capacity has been increasing through combining multiple, separately modulated optical carriers at distinct wavelengths onto a single fiber. This technique is known as wavelength-division multiplexing (WDM). Due to WDM, it is preferable that dispersion compensation be performed for multiple wavelengths using a common device.

Several methods have been proposed to compensate for dispersion, including fiber Bragg gratings, optical all-pass interference filters and dispersion compensating fiber. Dispersion compensating fiber (DCF) has found widespread practical acceptance and deployment due to its numerous advantages. Such advantages include relatively low loss and cost and the ability to simultaneously compensate channels across multiple wavelengths without requiring spatial separation. Further, DCF has the ability to compensate for the unavoidable variation in the dispersion as a function of wavelength (second-order dispersion or dispersion slope) that exists in many current transport fibers.

To compensate for positive dispersion in a transmission fiber, conventional systems use lengths of DCF that have a negative dispersion coefficient. The length of DCF is selected so that the negative dispersion produced by the DCF counteracts the positive dispersion in the transmission fiber. While DCF provides adequate levels of dispersion compensation, it is difficult to produce DCF that also simultaneously compensates the dispersion slope. As transmission lengths between regeneration points increase, the need to compensate dispersion slope is paramount. Uncompensated dispersion slope results in system penalty and can significantly shorten transmission distances and/or channel counts. Ideally, upon reception each channel should have the same amount of net dispersion so that the net dispersion slope is zero. Thus, there is a need for a system that both compensates for dispersion and net dispersion slope.

### SUMMARY OF THE INVENTION

An exemplary embodiment of the invention is an optical communications network transmitting signals on multiple wavelengths. The network includes a first dispersion compensating fiber providing dispersion compensation and dispersion slope compensation. The first dispersion compensating fiber has a first non-zero dispersion coefficient and a first non-zero dispersion slope coefficient. The network also includes a second dispersion compensating fiber in optical communication with the first dispersion compensating fiber. The second dispersion compensating fiber has a second non-zero dispersion coefficient and a second non-zero dispersion slope coefficient. The lengths of first dispersion compensating fiber and second dispersion compensating fiber are selected to compensate dispersion and compensate dispersion slope in a transmission path in optical communication with the first dispersion compensating fiber and the second dispersion compensating fiber. The compensation of dispersion and dispersion slope in the transmission path occurs simultaneously for multiple wavelengths. Alternate embodiments include a method of compensating dispersion in an optical communications network.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram of a communications system in an embodiment of the invention;

FIG. 2 is a graph of net dispersion versus frequency band for multiple DCF configurations;

FIG. 3 is a block diagram depicting dispersion compensation modules in a first embodiment of the invention;

FIG. 4 is a block diagram depicting dispersion compensation modules in a second embodiment of the invention; and,

FIG. 5 is a flowchart of a method of designing an optical network in an embodiment of the invention.

### DETAILED DESCRIPTION OF THE INVENTION

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

The expression “optically communicates” as used herein refers to any connection, coupling, link or the like by which optical signals carried by one optical system element are imparted to the “communicating” element. Such “optically communicating” devices are not necessarily directly connected to one another and may be separated by intermediate optical components or devices. Likewise, the expressions “connection” and “operative connection” as used herein are relative terms and do not require a direct physical connection.

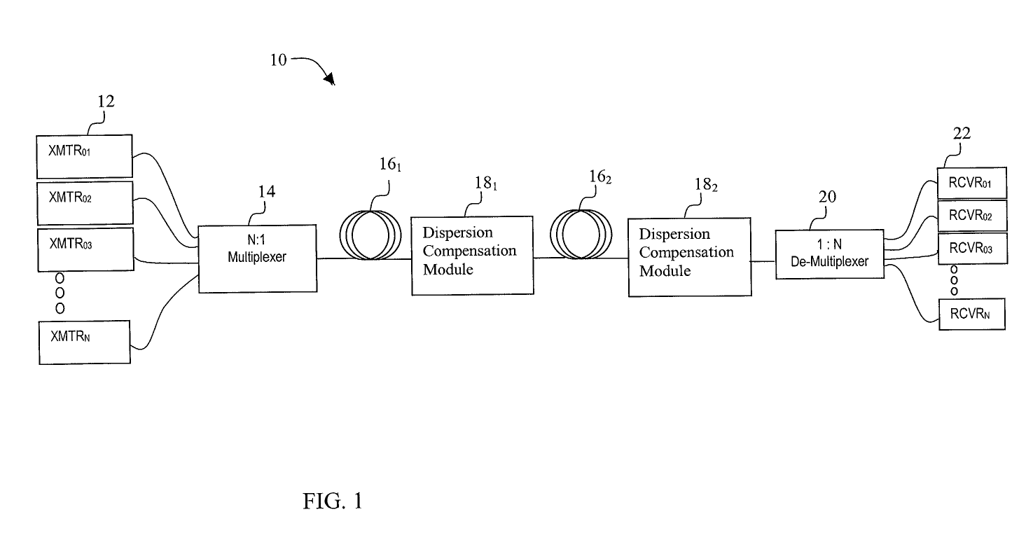

FIG. 1 depicts an optical communications network 10 in an exemplary embodiment of the invention. The network 10 includes a number of transmitters 12, each generating data on a distinct optical wavelength for transmission over the network. The transmitters (XMTR₀₁-XMTR_{N}) 12 optically communicate with an optical multiplexer 14 that combines the individual signals into a multiplexed signal. The multiplexed signal is optically communicated to transmission fiber 16. In the preferred embodiment, the transmission fiber 16 is non-dispersion shifted fiber (NDSF) but may be implemented using other types of fiber such as dispersion-shifted fiber (DSF).

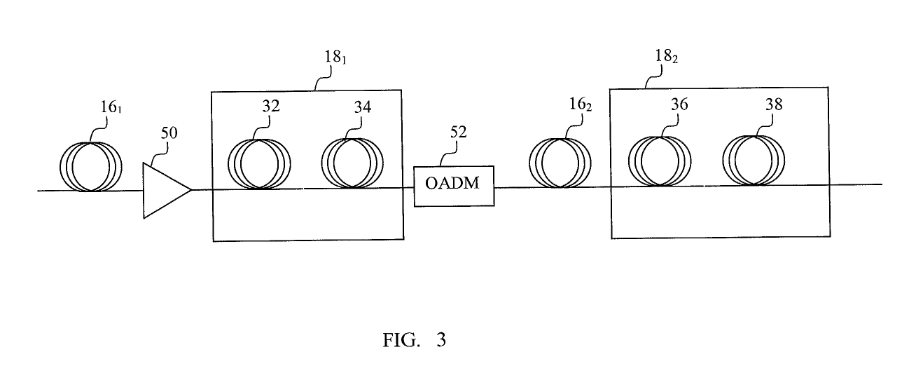

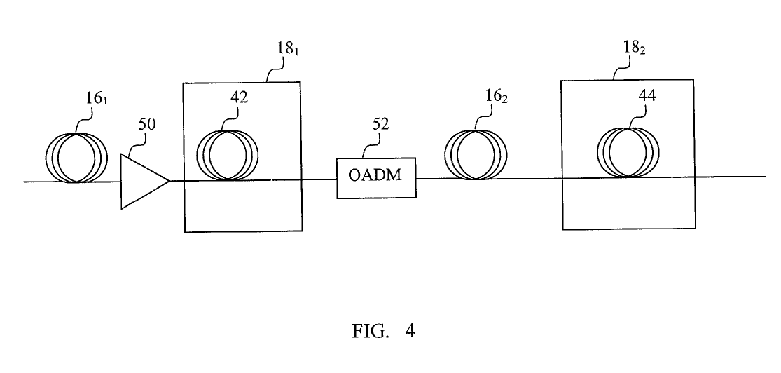

Dispersion compensation modules 18 are in optical communication with transmission fiber 16. Each dispersion compensation module 18 includes dispersion compensating fiber as described herein with reference to FIGS. 3 and 4. A demultiplexer 20 in optical 20 communication with the transmission fiber 16 demultiplexes the WDM signal and directs each optical carrier to an appropriate receiver (RCVR₀₁-RCVR_{N}) 22 designated for a particular wavelength.

For optimal operation, the dispersion compensation modules 18 should compensate for dispersion in the transmission fiber 16 and provide a zero net dispersion slope across channels. If each dispersion compensation module 18 includes a single type of DCF, this optimum design may be represented mathematically below. If D is the dispersion coefficient in ps/nm/Km, S is the dispersion slope coefficient in ps/nm²/Km, and L is the length in Km, an optimally dispersion and slope compensated system satisfies equations (1) and (2) below:

Dₜᵣₐₙₛ*Lₜᵣₐₙₛ+D_{dcf}*L_{dcf}=0 (1)

Sₜᵣₐₙₛ*Lₜᵣₐₙₛ+S_{dcf}*L_{dcf}=0 (2)

The subscript “trans” refers to transmission fiber 16 and subscript “dcf” refers to compensating fiber in dispersion compensation modules 18. D and S are constants, for both transmission fiber and dispersion compensating fiber. Lₜᵣₐₙₛ (length of transmission fiber 16) is fixed by the characteristics of the optical network. The only variable available to the system designer is the length of the DCF, L_{dcf}. That one variable cannot, in general, satisfy both equations (1) and (2) unless the following equality holds:

Dₜᵣₐₙₛ/Sₜᵣₐₙₛ=D_{dcf}/S_{dcf} (3)

For the equality in equation 3 to be met, a different piece of DCF fiber will have to be made to match each transmission fiber. This approach is both difficult to realize and not commercially viable given the requirement to stock numerous different types of DCF and limited availability.

To overcome the limitations of a single type of DCF, an exemplary embodiment of the invention uses two different types of DCF. Both DCFs compensate dispersion and dispersion slope of the transmission fiber. The different types of DCF, however, have different dispersion characteristics, particularly different dispersion slope coefficients. The optimum design using two types of DCF may be represented mathematically below:

Dₜᵣₐₙₛ*Lₜᵣₐₙₛ+D_{dcf1}*L_{dcf1}+D_{dcf2}*L_{dcf2}=0 (4)

Lₜᵣₐₙₛ*Sₜᵣₐₙₛ+L_{dcf1}*S_{dcf}+L_{dcf2}*S_{dcf2}=0 (5)

where subscript dcf1 corresponds to a first type of DCF and subscript dcf2 corresponds to a second type of DCF. The use of two types of DCF provides two variables L_{dcf1} and L_{dcf2}. Thus, the two lengths of DCF can be selected so that both equation 4 and equation 5 are satisfied.

The invention is not limited to compensating for first order effects (i.e., dispersion) and second order effects (i.e., dispersion slope). Additional equations may be utilized to determine the compensation needed for higher-order effects. For example, to compensate for third order effects, a third equation may be used and a third type of DCF selected so that three variables are used to solve the three equations. This technique may be extended to Nth order effects by using N equations and N types of DCF.

Equations (4) and (5) may be modified to include terms representing dispersion introduced by components in the transmission path. Components such as gratings, amplifiers, switches, optical add/drop multiplexers, etc., may be placed in the transmission path for which dispersion compensation is computed. These components may affect dispersion and dispersion slope. If components are present in the transmission path, constants Dcomponent and Scomponent may be added to equations 4 and 5, respectively, so that the dispersion effect of these components is addressed.

It should also be noted that equations 4 and 5 are independent of wavelength, so the equations essentially apply over all wavelengths. Thus, the use of two different types of DCF is preferred over techniques that divide the transmission wavelengths into multiple bands and employ a separate DCF for each band. In the exemplary embodiments, dispersion compensation and dispersion slope compensation occur simultaneously for multiple wavelengths carried by the transmission fiber.

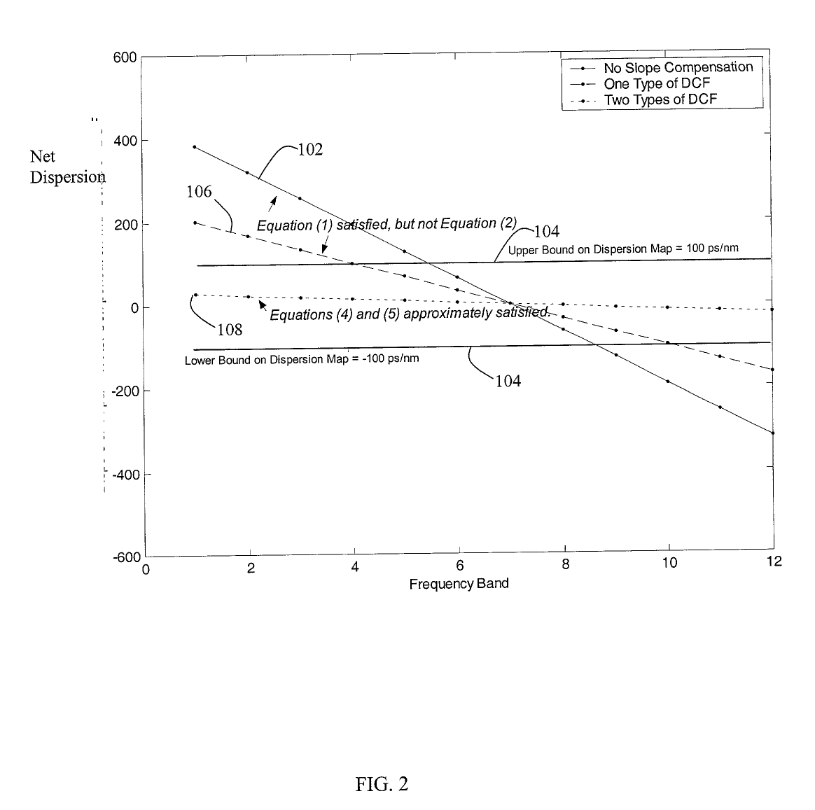

FIG. 2 illustrates the advantage of having DCF with two distinct slopes, where the transmission fiber is assumed to be non-dispersion-shifted fiber (NDSF). If a single DCF is used having zero slope compensation, then the net dispersion across multiple frequency bands is represented by the downward-sloping line 102. The length of DCF is selected so that equation (1) above holds true at a central wavelength (e.g., band 7). Equation (2) can never be satisfied if the DCF has zero slope compensation, because S_{dcf}=0, so the net dispersion after dispersion compensation must always have non-zero slope.

The two horizontal lines 104 show upper and lower bounds on net dispersion, which can differ from system to system. These bounds are arbitrarily designated at +/−100 ps/nm for the sake of illustration. For sake of illustration, it is assumed that net dispersion must be brought within these bounds in order for a wave division multiplexed (WDM) system to function properly.

If one type of DCF is used that provides dispersion compensation and slope compensation, then the net dispersion flattens out somewhat, as shown by the dashed line 106. However, net dispersion in frequency bands 1 through 5 and 9 through 12 still falls outside the acceptable bounds 104.

Adding a second type of DCF and selecting lengths for the first DCF and second DCF to satisfy equations (4) and (5) causes the net dispersion to have substantially zero slope as shown in line 108. The first DCF and second DCF each provide dispersion compensation and dispersion slope compensation. Line 108 would have a zero slope if the lengths of first and second DCF were selected based on the exact solution of equations (4) and (5). Line 108 has a slight negative slope because the lengths of first DCF and second DCF were selected from commercially available discrete amounts (e.g., 10 Km, 20 Km, 30 Km, etc.). Nevertheless, in practice, the net dispersion achieved by using two different types of DCF, in accordance with the invention, will fall within the permitted upper and lower bounds 104.

It is seen from FIG. 2 that use of two different types of DCF allows for solving equations (4) and (5) to yield substantially zero net dispersion across all operating wavelengths of the transmission fiber. Ideally, only two different types of DCF are needed, namely one DCF having a dispersion slope for compensating transmission fiber having the lowest dispersion slope, and another DCF having a dispersion slope for compensating transmission fiber having the highest dispersion slope. In such a scenario, all other transmission fibers (having dispersion coefficients between the lowest and highest) could be fully dispersion and slope compensated using the two DCFs with appropriate length ratios.

It is understood that the invention is not limited to use of two different types of DCF, but may employ any number of different types of DCF. The optimal design provided above in equations (4) and (5) can be generalized for n sections of different DCF as follows:

Dtrans*Ltrans+Ddcf1*Ldcf1+Ddcf2*Ldcf2+ . . . Ddcfn*Ldcfn=0 (6)

Ltrans*Strans+Ldcf1*Sdcf1+Ldcf2*Sdcf2+ . . . Ldcfn*Sdcfn=0 (7)

Exemplary embodiments for providing multiple different types of DCF will now be described. An exemplary system in a first embodiment of the invention is shown in FIG. 3. FIG. 3 depicts an inter-network element dispersion compensation approach and FIG. 4 depicts a span-based, terminal-to-terminal dispersion compensation approach.

As shown in FIG. 3, sections of transmission fiber 16 are in optical communication with dispersion compensation modules 18. These sections optically connect network elements along the transmission path. Additional components such as amplifiers 50 or optical add/drop multiplexers (OADM) 52 may also be in optical communication with the transmission fiber 16 and dispersion compensation modules 18. These additional components (e.g., amplifiers, OADMs, switches, gratings, etc.) may contribute to the dispersion and dispersion slope of the transmission path between network elements and be compensated by dispersion compensation modules 18.

In the embodiment shown in FIG. 3, each dispersion compensation module 18 includes two types of DCF having lengths selected to compensate for a section of transmission fiber 16 and optionally, any associated components. For example, dispersion compensation module 18₁ includes a first type of DCF 32 and a second type of DCF 34, each having different dispersion coefficients and/or different dispersion slope coefficients. Additional details concerning the physical implementation of the dispersion compensation module 18 may be found in U.S. Patent Application Ser. Nos. 09/137,408 and 09/551,131, the entire contents of both of which are incorporated herein by reference. DCF 32 and DCF 34 each provide both dispersion compensation and dispersion slope compensation. The length of DCF 32 and length of DCF 34 are selected based on the solutions to equations (4) and (5) for transmission fiber 16₁, and optionally any associated components. The physical implementation of DCF 32 and DCF 34 may not correspond exactly to the lengths dictated by the solution of equations (4) and (5).

As noted above, the lengths of DCF 32 and DCF 34 may be limited to commercially available lengths (e.g., 5 km, 10 km, 20 km). For example, if the solution to equations (4) and (5) indicates that DCF 32 should be 9 km and DCF 34 should be 41 km, then the physical implementation may use 10 km of DCF 32 and 40 km of DCF 34. Of course, the exact lengths of DCF 32 and DCF 34 computed using equations (4) and (5) may be used in the dispersion compensation module 18₁.

Similarly, dispersion compensation module 182 includes a first type of DCF 36 and a second type of DCF 38, each having different dispersion coefficients and different dispersion slope coefficients. Again, DCF 36 and DCF 38 each provide both dispersion compensation and dispersion slope compensation. The length of DCF 36 and length of DCF 38 are selected based on the solution for equations (4) and (5) for transmission fiber 162, and optionally, any associated components. The physical implementation of DCF 36 and DCF 38 may not correspond exactly to the lengths dictated by the solution of equations (4) and (5). As noted above, the lengths of DCF 36 and DCF 38 may be limited to commercially available lengths (e.g., 5 km, 10 km, 20 km).

In the embodiment shown in FIG. 3, each dispersion compensation module 18 includes lengths of different DCF selected to compensate for dispersion in a single section of transmission fiber 16, and optionally, any associated components. This embodiment is referred to as inter-network element compensation because the dispersion compensation module 18 compensate for dispersion in a section of the transmission path extending between two network elements. The network elements may be, for example, amplifier sites.

In a second embodiment of the invention shown in FIG. 4, lengths of DCF are selected to compensate for dispersion along the entire terminal-to-terminal path (also referred to as a span) and optionally, any associated components. As noted above, additional components such as amplifiers 50 or optical add/drop multiplexers (OADM) 52 may also be in optical communication with the transmission fiber 16 and dispersion compensation modules 18. In this embodiment, each dispersion compensation module 18 includes a single type of DCF and the lengths of DCF are selected based on the solution to equations (4) and (5) for the entire span or terminal-to-terminal transmission path. At least two dispersion compensation modules 18 employ DCF having different dispersion slopes.

As shown in FIG. 4, dispersion compensation module 18₁ includes DCF 42 and dispersion compensation module 18₂ includes DCF 44, having a dispersion coefficient and/or a dispersion slope coefficient different than those of DCF 42. DCF 42 and DCF 44 each provide both dispersion compensation and dispersion slope compensation. The lengths of DCF 42 and DCF 44 are based on the solution of equations (4) and (5) for the terminal-to-terminal transmission path including transmission fiber sections 16₁ and 16₂ and optionally, any associated components.

As shown in FIG. 1, the terminal-to-terminal path corresponds to the optical components coupling the multiplexer 14 to the demultiplexer 20. Thus, the embodiment of FIG. 4 determines the amount of each type of DCF based on dispersion across the terminal-to-terminal path or span between two terminals in an optical network. In both embodiments, the dispersion compensation modules 18 may be located at component sites such as amplifier sites, OADM sites, switching sites, etc.

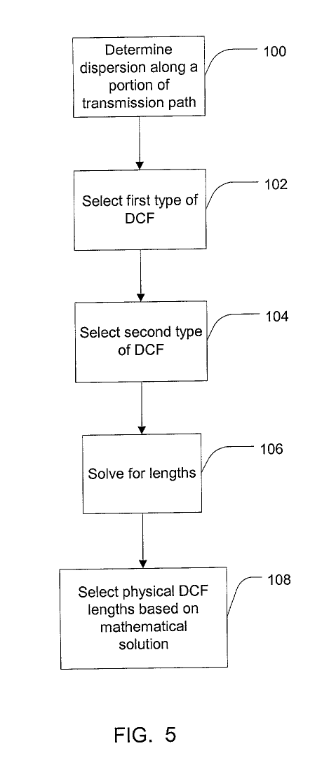

FIG. 5 is a flowchart of a process for selecting lengths of DCF when designing an optical network. This process may be implemented through a computer program that aids a system designer in designing an optical network. Alternatively, the process may be performed in the field by personnel updating an existing network. The process begins at step 100 where the transmission dispersion to be compensated is determined. The transmission dispersion may correspond to an inter-network element section of transmission fiber as described above with reference to FIG. 3 or a terminal-to-terminal transmission path as described with reference to FIG. 4, and optionally, any associated components. Step 100 provides the Dₜᵣₐₙₛ, Lₜᵣₐₙₛ and Sₜᵣₐₙₛ values used in equations (4) and (5). The determination of the transmission dispersion may be done at the design stage through computations or in the field by measuring actual dispersion through test instruments.

Flow then proceeds to steps 102 and 104 where the first type of DCF and the second type of DCF are selected. Both types of DCF provide dispersion compensation and slope compensation, but have different dispersion coefficients and/or dispersion slope coefficients. Steps 102 and 104 provide the D_{dcf1}, S_{dcf1}, D_{dcf2} and S_{dcf2} values used in equations (4) and (5).

At step 106, equations (4) and (5) are solved to provide values for L_{dcf1} and L_{dcf2}. At step 108, physical lengths of the first type of DCF and the second type of DCF are selected based on the mathematical solution for L_{dcf1} and L_{dcf2}. As noted above, the mathematically computed DCF lengths may be used, but such a practice may not be commercially viable because DCF is readily available in predetermined lengths. Accordingly, physical lengths for the first and second DCF may be selected to approximate the mathematical solution while maintaining the net dispersion within certain boundaries such as +100 ps/nm and −100 ps/nm.

The present invention allows a system designer flexibility in configuring WDM system with adequate dispersion compensation. For example, although a segment of DCF may have suitable dispersion for use in a particular WDM system, the fiber may nonetheless have excessive insertion loss, thereby precluding its use in that system. Consistent with the present invention, however, combinations of readily available DCF with acceptable insertion loss can be mixed and matched to achieve the desired amount of dispersion and dispersion slope compensation.

The invention being thus described, it will be obvious that the same may be varied in many ways. Such variations are not to be regarded as departure from the spirit and scope of the invention, and all such modifications as would be obvious to one skilled in the art are intended to be included within the scope of the following claims.

What is claimed is:

1. A method of compensating dispersion in an optical communications network having a transmission path transmitting signals on multiple wavelengths, the method comprising:
determining an amount of dispersion compensation needed for the transmission path;
selecting a first dispersion compensating fiber, the first dispersion compensating fiber having a first non-zero dispersion coefficient and a first non-zero dispersion slope coefficient;
selecting a second dispersion compensating fiber in optical communication with the first dispersion compensating fiber, the second dispersion compensating fiber having a second non-zero dispersion coefficient and a second non-zero dispersion slope coefficient;
determining a mathematical solution compensating dispersion in the transmission path and compensating dispersion slope in the transmission path;
selecting a length for the first dispersion compensating fiber and a length for the second dispersion compensating fiber in response to the mathematical solution;
the length of said first dispersion compensating fiber and the length the second dispersion compensating fiber compensate dispersion and compensate dispersion slope in the transmission path simultaneously for multiple wavelengths.

2. The method of claim 1 wherein the first non-zero dispersion coefficient is different from the second non-zero dispersion coefficient.

3. The method of claim 1 wherein the first non-zero dispersion slope coefficient is different from the second non-zero dispersion slope coefficient.

4. The method of claim 1 wherein the transmission path includes an inter-network element section of transmission fiber.

5. The method of claim 4 wherein the transmission path includes a component in optical communication with the inter-network element section of transmission fiber.

6. The method of claim 1 wherein the transmission path extends between a first terminal to a second terminal to define a terminal-to-terminal path.

7. The method of claim 6 wherein the transmission path includes a component in optical communication with the terminal-to-terminal path.

8. The method of claim 1 wherein the mathematical solution is represented as:
Dₜᵣₐₙₛ*Lₜᵣₐₙₛ+D_{dcf1}*L_{dcf1}+D_{dcf2}*L_{dcf2}=0
Lₜᵣₐₙₛ*Sₜᵣₐₙₛ+L_{dcf1}*S_{dcf1}+L_{dcf2}*S_{dcf2}=0
where D is dispersion coefficient, L is length and S is dispersion slope coefficient.

9. The method of claim 1 wherein the length of first dispersion compensating fiber and the length of second dispersion compensating fiber are selected based on discrete lengths approximating the mathematical solution.

10. The method of claim 1 wherein said determining the amount of dispersion compensation is performed in a design process.

11. The method of claim 1 wherein said determining the amount of dispersion compensation is performed through measurement.

12. The method of claim 1 wherein the mathematical solution compensates for Nth order dispersion effects in the transmission path, where N is greater than

13. The method of claim 1 wherein the mathematical solution includes a value representing dispersion introduced by components in the transmission path.

14. The method of claim 1 wherein the mathematical solution includes a value representing dispersion slope introduced by components in the transmission path.
